(19) United States
(12) Patent Application Publication
(10) Pub. No.: US 2013/0205650 A1
(43) Pub. Date: Aug. 15, 2013

(54) System and Method for Renewable Fuel Using Sealed Reaction Chambers

(71) Applicant: Jon Strimling, Bedford, NH (US)

(72) Inventor: Jon Strimling, Bedford, NH (US)

(21) Appl. No.: 13/687,449

(22) Filed: Nov. 28, 2012

Related U.S. Application Data
(60) Provisional application No. 61/564,194, filed on Nov. 28, 2011.
(60) Provisional application No. 61/564,195, filed on Nov. 28, 2011.
(60) Provisional application No. 61/569,058, filed on Dec. 9, 2011.
(60) Provisional application No. 61/569,053, filed on Dec. 9, 2011.

(51) Int. Cl. B01J 19/18; B01J 7/00

(52) U.S. Cl. CPC B01J 19/18; B01J 7/00
USPC 44/307; 422/129; 422/237; 422/224; 422/198; 422/209; 422/119; 422/187; 252/372

(57) ABSTRACT

The system and method described herein provide for the higher production rate fractionation of biomass for the purpose of selectively separating specific volatile components, which may subsequently be used in the production of a renewable liquid fuel, such as gasoline. Increased production rates of processing of biomass or other feedstock is achieved through the use of sealed reaction chambers, which may be transferred in a sealed configuration between stations in a multi-station processing system. Also, the present invention considers the use of piston assemblies for the dual functions of controlling fluid intake and exhaust (in combination with valves) and for providing a more robust and more cost effective sealing mechanism. The present invention may also achieve improved uniformity of biomass processing through the introduction of a mechanical agitator designed to mix the biomass during processing.

### RELATED APPLICATIONS

This application claims the benefit of the following U.S. Provisional Patents Applications: Ser. No. 61/564,194, titled “System and Method for Producing Renewable Fuel Using Sealed Cartridges” filed Nov. 28, 2011; Ser. No. 61/564,195, titled “System and Method for Producing Renewable Fuel Using Stationary Pressure Chambers” filed Nov. 28, 2011; Ser. No. 61/569,058, titled “System and Method for Producing Renewable Fuel Using Sealed Cartridges” filed Dec. 9, 2011; and Ser. No. 61/569,053, titled “System and Method for Producing Renewable Fuel Using Stationary Pressure Chambers” filed Dec. 9, 2011, all of which are incorporated by reference herein.

### BACKGROUND

1. Field of Invention

The invention relates to a system and method of using stationary pressure chambers and sealed cartridges to produce renewable fuel from biomass.

2. Discussion of Related Art

During the production of renewable fuels, it is often advantageous to react a fluid with solid materials for the purpose of generating known reaction products in a controlled manner. It is desirable that such processes subject the reactants to temperatures and pressures which are as uniform, accurate, and precise as possible. It is also desirable that variations in temperature occur as evenly throughout the reactants as possible. In such cases it is commonly required that the resulting products be collected separately at various stages of processing. For example, in the mechanical processing of an organic solid feedstock or reactant, such as biomass, for the purpose of extracting volatile elements for the production of liquid transportation fuels or other purposes, it may be advantageous to control the temperature, pressure and fluid composition of the environment surrounding the feedstock in successive steps. Controlling such environmental factors allows for the production and collection of different, specific volatile elements in each step, rather than producing a wide variety of relatively unusable reaction products all at once.

In order to accurately control pressure and temperature profiles, state-of-the-art methods, described by U.S. Patent Publication Numbers 2010/0180805, 2011/0209386 A1, 2011/0177466 A1 and 2011/0212004 A1, which are incorporated herein in their entirety, rely on trays carrying thin layers of compressed biomass which move from station to station. These collective descriptions of state-of-the-art methods represent a significant improvement over traditional processes of pyrolysis, in that through the methods described, the biomass materials are typically heated in successive stations, each of which drives off specific volatile compounds, which can then be more easily processed into renewable fuels.

These state-of-the-art methods specifically referenced above overcame a significant challenge of traditional pyrolysis, which had been that in heating biomass in large batches over broad ranges of temperatures, a wide variety of gaseous and liquid compounds were produced in forms that were of mixed composition, and were therefore difficult to further process to make renewable fuels. This process had been further complicated by the thousands of compounds in biomass feedstock, by the fact that the products of pyrolysis are often not thermodynamically stable, and by the fact that it had been difficult to consistently maintain narrow ranges of pressure and temperature in three dimensional commercial pyrolysis systems.

To maintain temperature and pressure uniformity at each station in processing, the state-of-the-art methods utilize a thin layer of compressed biomass, typically ⅛ of an inch thick, to maintain temperature uniformity during heating. The benefit of this thin, nearly 2-dimensional layer and processing the biomass in narrow temperature range, the biomass can be selectively decomposed in multiple stages at successive stations, with specific volatile compounds released at each step of the process.

Biomass is typically comprised of a wide array of compounds classified within the categories of cellulose, hemicelluloses, lignin, starches, and lipids. These compounds go through multiple steps of decomposition when subject to the pyrolysis process. For example, hemicelluloses comprise C5 sugars such as fructose and xylose, which yield furfural and hydroxymethylfurfurals upon thermolysis. The latter compounds can be further converted to fuel intermediates furan and tetrahydrofuran. The relatively narrow temperature windows experienced within a processing station using the current art allow for the collection of these useful intermediates.

However, because the biomass layer must be limited to a thin layer for uniformity of heating, scaling up production quantities is more challenging that it would be for larger batches of material, and therefore requires larger, more expensive equipment and/or additional production lines. Furthermore, because state-of-the-art methods and systems typically heat only surface of the biomass layer and the compressed nature of the biomass layer limits exposed surface area, heating and cooling remains non-uniform despite the aforementioned thickness limitations. Another drawback of state-of-the-art methodology is that the reduced surface area created by compressing the biomass into a thin layer also decreases the surface to volume ratio, and therefore increases the time required to first heat, second produce the desired reaction products, and third diffuse the reaction products back into the fluidic environment. It should be noted that with the state-of-the-art methods, the diffusion of volatile organic compounds from the bottom layer of the layer of biomass is slowed by the compression of that layer of biomass, which inhibits fluid flow to and from biomass particles on the unexposed side of the compressed layer of biomass.

To generate the proper operating environment, state-of-the-art methods further require a flexible bellows to be lowered over, and sealed to the top of, the tray at each processing station. Such designs have been commonly employed in small scale experimental uses, but are challenging to scale up for high volume processing. Additionally, these bellows designs typically have flexible seals which are susceptible to failure on repetitive cycling, so while they are appropriate for short term experimental use, they present reliability challenges at a commercial production scale. This is particularly true in an environment with supercritical fluids or volatile organic chemicals circulating, which may damage the flexible members, and is also especially true with high pressure differentials between stations, which increase the stresses on the joints in a bellows assembly.

Further complications arise in state-of-the-art methodology when moving materials from one high pressure environment to the next, as from station to station during processing. Airlocks are often necessary to prevent leakage of high pressure fluids, or to stabilize pressure on either side of any seals prior to moving a tray. The incorporation of such airlocks further increases cost and decreases the mechanical reliability of equipment used to execute state-of-the-art methods.

A need therefore exists for a scalable, lower-cost, mechanically reliable, system and method of producing renewable fuels capable of more uniform heat distribution and generating more complete reactions in a reduced period of time.

### SUMMARY

The system and method described herein provide for the higher production rate fractionation of biomass for the purpose of selectively separating specific volatile components, which may subsequently be used in the production of a renewable liquid fuel, such as gasoline. Increased production rates of processing of biomass or other feedstock may be achieved through the use of sealed reaction chambers according to various embodiments of this invention. In one embodiment, this goal may be achieved through the use of cartridges which may be sealed once assembled, and which may be transferred between stations in a multi-station processing system, while preserving the fluidic environment surrounding the biomass during the transfer between processing stations. Also, a piston-cylinder assembly may be utilized to provide the multiple functions of pressure control, the intake of a working gas and the extraction of fluids produced. Improved uniformity of biomass processing may also be achieved through the introduction of a mechanical agitator designed to mix the biomass during processing.

Agitation can provide several benefits to the biomass conversion process. When rapidly stirring a solid in a fluid environment, the particles can be separated, exposing much higher surface area levels of the biomass to the working fluid. In addition, the relative motion of the fluid environment and the biomass may create higher fluid flows over the biomass, again helping to draw out volatile components. Agitation and mixing may help to homogenize the mixture's temperature, which may be important to ensuring that the volatile compounds produced are of a consistent and usable composition. Additionally, the mixing action itself may continue to break down and pulverize the biomass materials, in particular breaking down the largest particles which might otherwise not effectively volatilize compounds at their core.

The combination of these rate-accelerating factors along with removal of layer-thickness requirements enables a substantially higher mass flow rate of solid biomass may be processed, and a substantially higher mass flow rate of volatile compounds may be produced from a given physical size of apparatus, reducing the capital costs of equipment per unit of renewable fuel that may be produced.

Various embodiments of the system described herein effectively agitate and mix the biomass with a working fluid contained in the sealed reaction chamber throughout a specified temperature and pressure profile. The fluid contained in a sealed reaction chamber may be liquid, gaseous, supercritical or multi-phase. Such working fluids may include, for example, a supercritical carbon dioxide rich and reduced oxygen fluid. Alternatively, for processing other feedstocks, it may be practical to utilize elements of the present invention in the processing of solid feedstocks within a gaseous, liquid, or mixed phase fluid environment.

In one embodiment, the sealed reaction chamber may be in the form of a rotary drum cartridge, with biomass being tumbled internally in a drum rotor. In another embodiment, the sealed reaction chamber may be in the form of a cylindrical cartridge with a mixer blade agitating the biomass. It will be apparent in view of this disclosure that many other sealable cartridges of various designs may be used in accordance with various embodiments of the present invention.

In addition, it should be understood that while it may be advantageous to utilize a sealed cartridge, which may contain both biomass and a fluidic environment, in transferring biomass from one station to another in a series of processing steps, there are alternative embodiments where the reaction chamber is only sealed during processing, and is opened or separated between processing steps.

The seals in prior tray systems were maintained by flexible bellows sealing to the top of the trays, which can be problematic from the standpoint of mechanical reliability, particularly in an environment with volatile organic chemicals circulating supercritical fluids and high pressure differentials. The present invention considers the use of piston assemblies for the dual functions of controlling fluid intake and exhaust (in combination with valves) and for providing a more robust and more cost effective sealing mechanism.

In embodiments where a cartridge may be used to transfer materials from station to station, the flow of fluid into the cartridge may be controlled by valved ports, which may be fully sealed during transfer between stations. The cartridge as a whole may be indexed between processing stations in a sealed configuration, eliminating a series of sealing and working fluid control issues.

The present invention also provides a method for converting biomass to renewable fuels, the method comprising: providing a device containing a programmable number of processing stations, and a series of catalysts; inserting biomass into a plurality of sealed cartridges; injecting the cartridges with a working fluid; indexing the sealed cartridges from station to station, wherein the stations heat the contents of the cartridges to a desired temperature profile, such that the biomass decomposes into volatile and non-volatile components; selectively collecting groups of volatile compounds as they are released; and subjecting the volatile components to a series of catalysts to produce at least one renewable fuel.

Also, a method for converting biomass to renewable fuels is provided, the method comprising: providing a device containing a programmable number of processing stations and a series of catalysts; subjecting biomass within the stations to at least one programmable starting temperature; incrementing an individual processing station temperature by programmable increments wherein the biomass is agitated at least one processing station to enhance the production of a volatile and a non-volatile component; and subjecting the volatile components generated in each station through the series of catalysts to produce at least one renewable fuel.

Further, the present invention includes a system for converting biomass to renewable fuels, the method comprising: a device containing a programmable number of processing stations, and a series of catalysts; means for inserting biomass into a plurality of sealed cartridges; means for injecting the cartridges with a working fluid; means for indexing the sealed cartridges from station to station; means for heating the contents of the cartridges to a desired temperature profile, such that the biomass decomposes into volatile and non-volatile components; means for collecting groups of volatile compounds as they are released; and means for subjecting the volatile components to a series of catalysts to produce at least one renewable fuel.

The present invention also provides a system for the conversion of biomass to combustible fuels, the system comprising: a device containing a programmable number of processing stations and a series of catalysts; means for subjecting biomass within the stations to at least one programmable starting temperature; means for agitating the biomass at individual processing stations; means for incrementing an individual processing station temperature by programmable increments to produce a volatile and a non-volatile component; and means for subjecting the volatile components generated in each station through the series of catalysts to produce at least one renewable fuel.

The subject matter of this application may involve, in some cases, interrelated products, alternative solutions to a particular problem, and/or a plurality of different uses of a single system or article.

### BRIEF DESCRIPTION OF THE DRAWINGS

FIG. 1 shows a side view and a front view of a drum rotor cartridge, with Sections A-A and B-B showing detailed views of the cartridge.

FIG. 2 shows a drum rotor cartridge incorporating an internal fan assembly.

FIG. 3 illustrates successive processing stations for indexing a cartridge.

FIG. 4 shows an embodiment of a cartridge, incorporating a mixing cartridge.

FIG. 5 shows a piston-cylinder-agitator assembly, with Sections A-A and B-B showing detailed views of the assembly.

FIG. 6 illustrates processing steps at a particular work station.

FIG. 7 shows the process steps for in particular implementation.

### DETAILED DESCRIPTION

Cartridge Embodiments

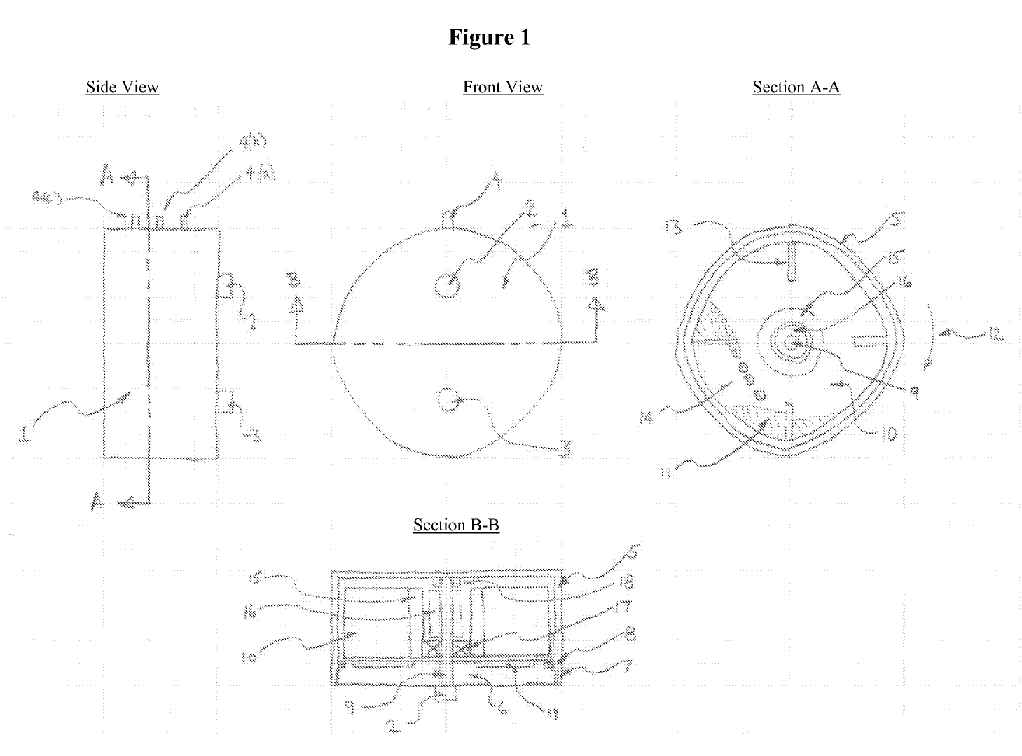

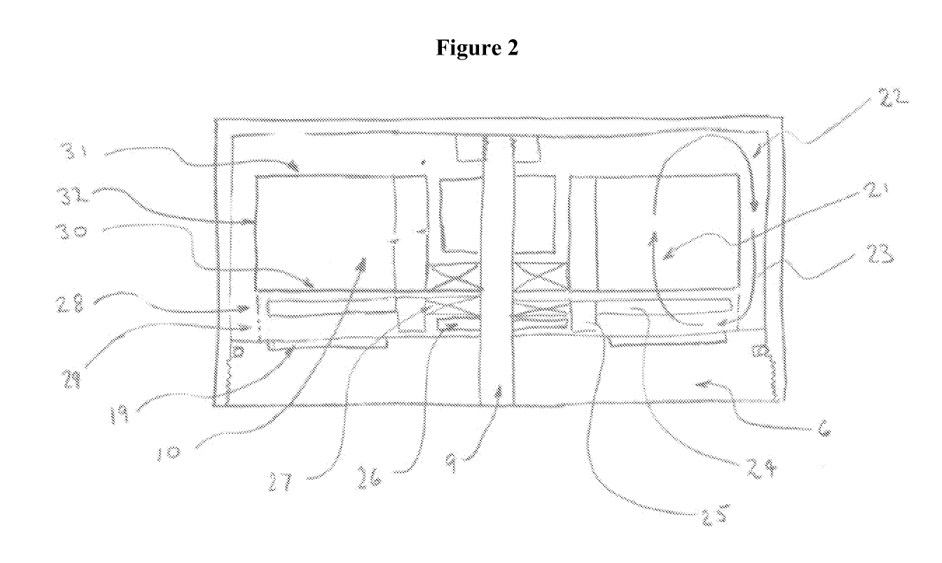

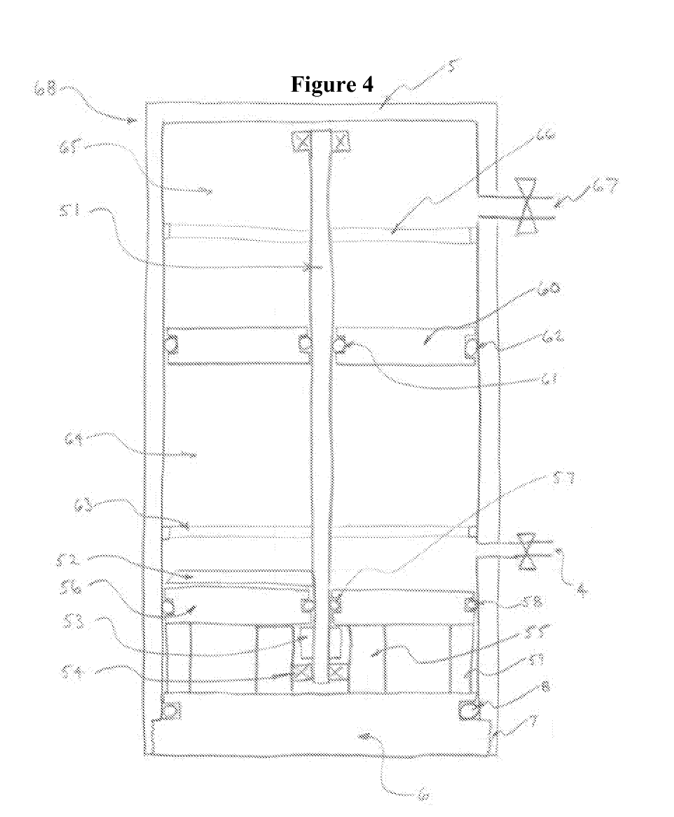

In one example embodiment, cartridges in accordance with various embodiments of the present invention may be utilized in the processing of solid biomass and the extraction of volatile components from the biomass in a supercritical fluid environment. There are a number of potential configurations for cartridges in accordance with the principles of the present invention. FIGS. 1 and 2 illustrate an exemplary drum rotor cartridge, and FIG. 4 illustrates an exemplary mixing cartridge, but it should be understood that any number of cartridge configurations may be practicable.

FIG. 1 illustrates a drum rotor cartridge in accordance with an embodiment of the present invention. As is shown in FIG. 1, various embodiments of the present invention proved that such cartridges can be implemented as self-contained units. The side view of FIG. 1 shows a drum rotor cartridge 1, with various ports that may be useful during feedstock processing. In some example embodiments the composition of the working fluid(s) can be, for example, supercritical carbon dioxide, water, methane, methanol, other small hydrocarbons, their oxygenates, and any mixture thereof (e.g. 60% CO₂, 30% Water, and 10% Methane and other organics) although any suitable gaseous, liquid, supercritical, or multi-phase fluid may be used. Cartridges suitable for use in such embodiments may include a fluid intake port 4 (a) and a fluid off-take port 4 (b). However, in some example embodiments fluid intake and off-take may occur through a common port. In still other embodiments there may be a plurality of intake and/or off-take ports. Again referencing the side view of FIG. 1, any number of additional ports 4 (c) may also be provided, each of which may be used to insert or attach features for viewing the interior of the cartridge or for the measurement of parameters such as, for example, temperature, pressure, or fluid composition.

As shown in FIG. 1, Section B-B, an example drum rotor cartridge 1 may be sealed by utilizing a cover 5 and a base plate 6. In the example configuration shown in FIG. 1, Section B-B, the cover 5 can be threaded onto the base plate 6 by threads 7 and may thereby complete an o-ring seal 8. It will be apparent in light of this disclosure that, in lieu of a base plate-cover assembly, a clamshell or one of many other mating component designs may be formed to form a sealed cartridge, such as a cylinder with separable top and bottom caps. It will further be apparent in light of this disclosure that there are many alternative ways to close and seal the cartridge assembly, including bolting, snap-locks, and a variety of other mechanisms.

To provide additional stiffness and structural support for the cover 5 during pressurized operation, some example embodiments may include a boss 18, which may be affixed to the cover with internal threads mating to a central shaft 9. The central shaft 9 may be permanently or removably mounted to the base plate 6. The cover-central shaft-base plate assembly may be assembled such that the boss 18 is threaded onto the central shaft 9 simultaneous to the threading of the cover 5 to the base plate 6. However, in other example embodiments a removable central shaft 9 may be threaded into the boss 18 following assembly of the cover 5 and baseplate 6. In various example embodiments, the boss 18 can also provide lateral stability to the central shaft 9, about which, in some such embodiments, the drum 10 rotates. It will be apparent in light of this disclosure that there are a plurality of ways to reinforce the cover internally or externally, or that no reinforcement may be required. It will also be apparent that many various methods of stabilizing a central shaft may be employed, including the possibility of providing no stabilization to at least one end of the central shaft.

As shown in FIG. 1, Section B-B, the drum 10 may be supported by one or more bearings 17 and be driven by a rotor 15 mounted to the drum 10. In some examples a stator 16 may be mounted to the central shaft 9. Electrical signals may be transmitted to the stator 16 and, in some such example embodiments, may be controlled via inputs to a motor drive connector 2, and a rotational sensor (not shown). Such sensors may be used for timing electrical signals to the stator 16 in order to control the rotor 15. The rotary drum 10 may be driven in a continuous motion, in a reversing motion, or in a pulsed mode in either direction, as may be beneficial to providing the desired level of agitation of the biomass. While internal stator 16 and rotor 15 components have been shown for purposes of illustration in FIG. 1, it should be appreciated that rotation of the drum 10 may be driven by any number of motors and/or transmissions internally or externally connected to a cartridge. In the case of the connection of an external motor to a cartridge, a rotating shaft may pass into the cartridge to convey the rotary motion, while preserving a seal between the contents of the cartridge and the external environment.

Drums in accordance with example embodiments of the present invention may also include various other electrical devices such as, for example, a heater, measurement devices for determining drum position over time, internal component temperatures, and other suitable devices. As shown in the example embodiment illustrated by FIG. 1, Front View, all such electrical connections may be linked through electrical component connector 3, although any other suitable means of transferring electrical signals and/or making electrical connections may also be used in accordance with various embodiments of the present invention.

In accordance with an example drum rotor cartridge 1, as shown in FIG. 1 Section A-A, a rotary drum 10 may be located inside cover 5. Solid biomass 11 such as, for example, celluloses, hemicelluloses, lignin, starches, and/or lipids may be contained in the rotary drum 10. In accordance with the example embodiment illustrated by FIGS. 1 and 2, the inner and outer 32 circumferential surfaces of the rotary drum 10 may be a thin sheet of metal, and the sidewalls 30 and 31 may be a very fine wire mesh. The wire mesh may, in some embodiments, allow fluids to enter and leave the rotary drum 10 while retaining the biomass 11 inside of the drum.

A motion of the drum 10 is shown by arrow 12, showing clockwise rotation in the FIG. 1 Section A-A as shown. It will be apparent in light of this disclosure, however, that rotation in any direction and about any axis can be used in accordance with various embodiments of the present invention. As the rotary drum 10 rotates, particles of the biomass 14 can be agitated by internal ribs 13 in the rotary drum 10. Such agitation of the biomass 11 (or other feedstock) acts to accelerate the production of volatile compounds from the biomass.

Because tightly controlled temperatures within the cartridge 1 may be desirable in many embodiments, heating elements 19 or other heat sources can be provided and may be mounted to the base plate 6, the cover 5, the drum 10, or any other location suitable for varying the temperature of the working fluid and biomass 11. Internal temperature sensors (not shown) may be mounted to internal components such as the, for example, base plate 6, central shaft 9, cover 5, or drum 10 to measure fluid temperatures or component temperatures. Fluid temperatures may also be measured, for example, via ports 4 (c) or by a thermocouple or other probe inserted through a port down into the drum cartridge assembly. In one embodiment a heating element 19 may be operated in a closed-loop fashion to maintain a set temperature, follow a desired temperature profile over time, and/or follow a desired temperature profile in response to changes in other measurements within the drum, such as pressure readings or measurements of fluid composition.

FIG. 2 shows the addition of an internal fan, which may be utilized within a cartridge of any particular design to promote circulation of the working fluid, but here is illustrated in combination with the drum cartridge assembly described above. Additionally, it will become apparent in light of this disclosure that any number of configurations may be used to generate forced flow within a cartridge. Circulating the working fluid, as with the agitation of the biomass, may then have a tendency to (1) increase temperature uniformity within the cartridge and (2) promote the production of volatile compounds by increasing the fluid flow rates relative to the biomass that may be processed in the cartridge.

The fan assembly illustrated by FIG. 2 may, in some embodiments, be used to drive the flow of working fluid inside the cartridge 1 in a pattern shown by circulating arrows 21, 22 and 23. In the example shown, fluid may be driven by a fan blade 24 or blades through a first fine mesh screen side plate 30 of the drum 10, as shown by arrow 21. It should be noted that the view shown in FIG. 2 is rotated 90 degrees, and the central shaft 9 may normally be oriented horizontally such that the flow described by arrow 21 would also be substantially horizontal. In accordance with the example embodiment of FIG. 2, flow may continue out the second fine mesh screen side plate 31, positioned for example, opposite the first fine mesh screen side plate 30 of the drum 10, as is illustrated by arrow 22 and may then circulate outside the drum 10 around the sheet metal outer circumferential surface 32.

The flow, as is shown, for example, in FIG. 2, may be driven by a fan blade 24 or blades, which may be mounted on an independent rotor 25, driven by an independent stator 26, and supported by independent bearings 27. It should be understood by one skilled in the art that the fan's action could also be driven by the same rotor/stator/bearing set as enables the rotation of the drum, or any other suitable drive apparatus, but it may be desirable at times to control the flow rate of the fluid and the turning of the drum rotor independently, so an independent case is shown here.

As the flow circulates back to the fan blade 24 intake area, it may be helpful in some embodiments to provide a flow guide ring 28, which can be mounted to the base plate 6, and has a tight clearance to the drum 10 to prevent leakage between the flow guide ring 28 and the drum 10. The flow guide ring 28 may be a thin sheet metal cylinder and, in some embodiments, a portion of the flow guide ring closest to the base plate 6 and furthest from the drum 10 may include perforations 29, which permit the flow of fluid through the perforations as shown by arrow 23 while preventing parallel flow over the fan blade 24 or blades.

As the working fluid enters the fan intake area, the fluid may pass over a heating plate 19, adding heat to the working fluid. To enhance heat transfer at the heating plate, the heating plate may contain ribs or protrusions (not shown) that increase the surface area of the plate and enhance heat transfer to the working fluid contained in the cartridge. It will be apparent in light of this disclosure that the flows as shown may be reversed to provide impingement flows down onto the heating plate, assisting with heat transfer at the heating plate, and that any number of other circulation and heating strategies may be employed to provide for effective circulation and mixing of the fluid with the biomass 11 or other feedstock materials.

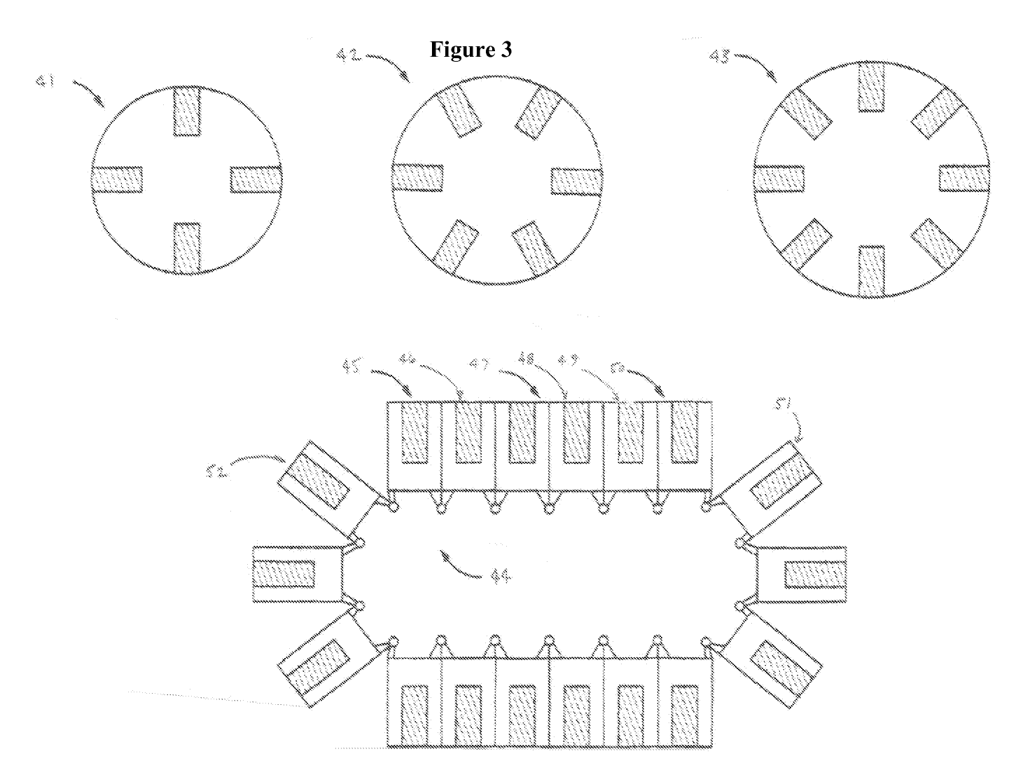

A cartridge according to an example embodiment of the present invention may be indexed through successive processing stations, as illustrated by FIG. 3. The cartridge may be indexed from station to station around a circular arrangement of stations 41, 42, and 43, or an elliptical arrangement of stations 44. An arrangement can be in any number of stations and/or shapes such as, for example, four processing stations in a circle 41, six processing stations in a circle 42, eight processing stations in a circle 43, and/or 18 stations in a racetrack configuration 44. Through the use of a cartridge, which can include a fluidic environment, conventional bellows and airlocks used for maintaining particular environmental conditions can be eliminated, thereby also eliminating all sealing, pressure management, mechanical reliability, station transfer, and other complications and difficulties associated therewith. Specifically, a cartridge-based system fully seals the biomass in a controlled environment throughout processing, including during transfer between stations.

It will be apparent in view of this disclosure that the fluidic environment may be pressurized, evacuated, or maintained at atmospheric conditions. The pressure of the fluidic environment can be, for example, in the range of 0-220 atmospheres (e.g. 45-80 atmospheres), but various embodiments may use any pressure suitable for processing. It will be further apparent that temperature may be set prior to transfer and maintained utilizing thermal insulation or that heating may continue during transfer. Processing temperatures often vary and may be, for example, in the range of 190-850° K. (e.g. 304-798° K., 512-748° K., or 598-698° K.) but may, in various embodiments, be any temperature suitable for processing. It will also be apparent in view of this disclosure that agitation may be utilized to mix the contents of the cartridge before, during, and/or after transfer to maintain a homogeneous mixture.

In the case, as illustrated by FIGS. 1 and 2, where a cartridge is a drum cartridge, a quantity of biomass may be dispensed into the rotary drum 10 by removing the cover 5 from the base plate 6. For some embodiments, such dispensing of biomass can be completed prior to indexing the drum cartridge 1 through the system. With the cover 5 removed, a door (not shown) in the sheet metal outer circumferential surface 32 of the drum 10 may be opened to allow biomass to be inserted into the drum 10. It will be apparent in view of this disclosure that a door may be present in the fine mesh screen side plates 30 or 31, and further that any number of alternative methods may also permit the dispensing of biomass into the drum 10. Following insertion of the biomass, the cover 5 may be reattached to the base plate 6 and the cartridge 1 thereby sealed. In cases where other cartridges may be utilized, suitable ports for the insertion of biomass, for the removal of residual carbonaceous material, and for the cleaning of cartridges may be provided. Whereas the following paragraphs describe indexing of materials through various processing steps utilizing a drum cartridge, it will be apparent in light of this disclosure that similar processes may be followed with other cartridge designs.

Once the cartridge has been loaded with biomass, the cartridge may be introduced into the arrangement of successive processing stations, beginning with the first station 45. In other embodiments the insertion of biomass may rather be performed at the first station. The cartridge may be successively indexed across a series of processing stations such as, for example, those labeled in FIG. 3 as 46, 47, 48, 49, 50 and 51, and with the last of the 18 stations in the example sequence of FIG. 3 being labeled 52.

At the first station 45, a cartridge in accordance with FIGS. 1 and 2 may be mated to fittings that connect to the various connection points on the cartridge. Specifically, fluid intake and off-take fittings may be connected to the fluid intake 4(a) and off-take 4(b) ports in the drum cartridge. Measurement connections for temperature, pressure and working fluid composition may be made via ports 4(c) that allow for physical insertion of measurement devices, or by way of electrical connections, with the physical probes internal to and integral within the drum cartridge. In some example embodiments electrical connections for driving the various motors that may exist within the drum 10 including, for example, the drum and a fan motor, can also be made at this time.

Further electrical connections may include, for example, those required for supporting a resistive heating element and can be made at the first station 45 or any subsequent station. It is alternatively possible to heat the drum via a host of other heating technologies, including, for example, heating via mechanical agitation, plasma heating, microwave heating, and heating the drum with a flow of heated working fluid through the fluid intake and off-take ports, or passing heat into the drum via a heat exchanger using a circulating fluid, such as heating oil. With any method of heating described above, heating connections may be made as the cartridge is moved to successive stations, utilizing a common interface architecture, and the heating connections may be electrical, fluidic or even mechanical, in the case of heating by agitation.

As may be required for some example processing sequences, the cartridge may be substantially purged of oxygen and any existing fluid by flowing a relatively non-reactive fluid in through the intake port 4(a) and out through the off-take port 4(b). The cartridge 1 may then be charged to a desired pressure with a fluid known to be advantageous for processing. As an example, in processing biomass for the production of liquid renewable fuels a supercritical fluid with high levels of carbon dioxide and low oxygen levels may be useful for the extraction of volatile compounds.

At the first processing station, the drum may be rotated to confirm appropriate feedback from the rotational sensors, and other components may also be tested to confirm proper operation of the heating elements, effective seals, and/or other appropriate preparations for processing may be undertaken.

The first processing station may then index the drum cartridge to a second processing station. Each successive station may be configured so that the drum cartridge assembly automatically connects with each successive station on a standardized interface, minimizing connection time and facilitating automation of the indexing process.

At the second processing station, the drum cartridge may be heated to an initial temperature T_start. The heat may be ramped to the desired T_start with the drum rotating, so as to effectively mix the biomass and ensure uniform heating of the biomass. During the heating ramp, a circulation fan may be run inside the drum cartridge, to preserve temperature uniformity. At each processing station, the exterior of the drum cartridge may be insulated, to prevent temperature loss from that exterior interface.

During the ramp to the desired T_start, the pressure in the drum cartridge may be controlled in a closed-loop fashion to follow a prescribed profile by utilizing the pressure measurement inside the drum cartridge or through one of the ports. The pressure within the drum cartridge may therefore be modulated at this station and in subsequent stations by introducing additional fluid via the fluid intake port, or by exhausting fluid from the fluid off-take port. This pressure and temperature modulation may be conducted on a continuous basis during processing in response to pressure and temperature readings, as well as measurements of working fluid composition.

Once the drum cartridge has reached the appropriate temperatures and pressures for optimized processing of biomass, which may be, for example, in the range of 190-850° K. (e.g. 304-798° K., 512-748° K., or 598-698° K.) and 0-250 atmospheres (e.g. 45-80 atmospheres), but may, in various embodiments, be any combination of temperature and pressure suitable for processing, the drum rotor speed and fan speed may be set to the desired rates for the production of volatile compounds from the biomass, and held there for an appropriate dwell time, or these rates may be continuously adjusted in response to feedback from the temperature, pressure and fluid composition measurements.

It may be desirable to utilize supercritical fluids in the drum cartridge during processing. For example, supercritical fluids may be helpful in assisting in processing by increasing the rates of heat transfer relative to gaseous environments and also by providing a substantial increase in chemical reaction rates, as compared to liquid environments, due to their much higher rates of diffusion. Appropriate mixtures of supercritical fluids vary and often depend on the types of reactants used and the types of reaction products desired at each processing step.

It may also be desirable to circulate fluids through the drum cartridge during processing. For example, if a carbon dioxide rich supercritical fluid were introduced via continuous flow into the intake port, and the biomass produces volatile organic compounds to be utilized by a downstream process to make renewable fuels, a supercritical fluid enriched with volatile organic compounds may be continuously removed from the off-take port during processing. Then the volatile organic compounds in the off-take flow may be utilized to make renewable fuels, with the carbon dioxide rich supercritical fluid eventually circulating and returned to the processing station via the intake port. By circulating flow through the intake and off-take ports, it may be possible to reduce the extent by which the fluid inside the drum cartridge may become saturated in desired products, such as volatile organic compounds, slowing their production.

When circulating fluids into an out of a cartridge containing biomass or other solid matter, the solid particles may tend to be drawn through the fluid intake and off-take ports. To prevent this, filters may be included on the inside of the ports, to separate out the solid matter. As the filters may periodically become soiled, it may be advantageous to reverse the flow of the fluid through the ports periodically to clean the filters.

The processing of a solid reactant, such as biomass, may be halted at a particular station when it has progressed to a desired point. This point may be determined by a fixed period of time, by a desired rise in pressure, or when a specific quantity of products, such as volatile compounds, may have been obtained.

In any case, once it is determined that it is time to progress to the next station, the intake and off-take valves may be closed. The drum may be allowed to continue to rotate for a period, maintaining the homogeneity of the mixture in the cartridge. The heating element may be utilized to maintain a holding temperature and the intake or off-take valves may also be utilized to maintain a holding pressure.

The full cartridge, containing biomass and the working fluid may then be indexed to the next station. Because both the biomass and the working fluid environment may be passed in a single cartridge, there may be no requirement for airlocks, or the re-establishment of seals, except for the internal seals within the appropriate valves.

The next station could simply continue the processing of biomass at a higher temperature with the same working fluid composition, it could add or subtract fluid to alter the working pressure and/or composition, or it may purge the contents of the cartridge and introduce an entirely new fluid composition, as may be appropriate to the subsequent processing step. In some embodiments the temperature may be increased at each new station by increments such as, for example, in the range of 0-200° K. (e.g. 25-50° K.), although it will be apparent in view of this disclosure that any station-to-station temperature increment suitable for processing may be used.

In the case of the production of volatile compounds from biomass in the production of renewable fuels, as the cartridge may be indexed through a series of stations, the temperatures may be increased, driving off additional volatile compounds of differing compositions as the biomass progresses. During this process, the biomass may go through multiple steps of decomposition and progress, for example, from an initial state which may be of a lipid rich biomass to an intermediate state of hemicellulose rich biomass to a final state of lignin rich biomass. In one example, a hemicellulose type may comprise C5 sugars such as fructose and xylose, which then further decompose to yield compounds such as furfurals and hydroxymethylfurfurals.

The tight temperature range at each station, which may be improved by agitation of the biomass and/or the fluid, may therefore allow specific volatile compounds to be collected at each station, and also may allow specific intermediary products of biomass decomposition to be collected and utilized in subsequent processing stations.

After processing of the feedstock material (such as biomass) is complete, the drum cartridge may be exhausted via the off-take port, and then the cover may be removed. Remaining carbonaceous materials may be poured out of the door in the drum rotor, and the drum rotor and entire drum cartridge assembly may be cleaned for re-introduction into processing of a subsequent batch of materials.

FIG. 4 shows another embodiment of a cartridge in accordance with the principles of the current invention, in this case, a mixing cartridge 68. In this case, the mixing of the biomass is driven not by a rotary drum, but by a rotating agitator blade 52. It should be understood that while two specific examples of agitation may be provided, a number of other means of agitation could be provided, including circulatory agitation, vibratory and heat driven agitation, and agitation by phase changing materials flow (such as the boiling of a liquid).

As shown in FIG. 4, to seal the mixing cartridge 68, a cover 5 may be sealed to a base plate 6, through the use of a screw thread 7 and a seal ring 8. The sealed mixing cartridge 68 may have ports 4 (one shown) for intake and off-take, and may also utilize such ports for measurement of temperature, pressure, gas composition and other process variables. The mixing cartridge 68 may also have other electrical connections for the motor and other internal electronics, which may be not shown in this figure, but have been previously described in the context of the drum cartridge.

As shown in this embodiment, the central shaft may be a rotary shaft 51, which may be rigidly connected to at least one mixer blade 52. It should be understood that there may be multiple mixer blades at various clock positions or altitudes, which may be rigidly attached to the rotary shaft. The rotary shaft may be driven by a rotor 53, supported by bearings 54 and driven by a stator 55.

Separating the motor assembly from the materials being processed above it, there may be a lower separation plate 56, which may be sealed at its interior and exterior by internal seal 57 and exterior seal 58. This lower separation plate may be rigidly attached to and supported from below by the stator 55 and a support ring 59. The solid material being processed, such as biomass, may sit on top of the lower separation plate and therefore be agitated as the mixer blade 52 circulates.

Higher up on the rotary shaft 52, there may be an upper separation plate 60, which has its own internal seal 61 and external seal 62. This separation plate may be free to travel vertically along the length of the cover, or there may be a lower stop ring 63 present to prevent it from traveling down and contacting the mixer blade or an upper stop ring 66 present to halt its upward travel.

There may be a working fluid cavity 64 created in the sealed volume between the upper separation plate 60 and the lower separation plate 56. The solid materials being processed in the cartridge, such as biomass and the fluid contained in the cartridge, may react in this working fluid cavity to produce the desired products at any station in the processing sequence.

There may be a separate upper pressurized cavity 65 above the upper separation plate 60, with the pressure in the upper pressurized cavity controlled by a pressurization port 67. The upper pressurized cavity may have a different fluid contained in it from the working fluid cavity, which may be liquid, gaseous, supercritical or multi-phase, and may not be intended to play any role in the reactions occurring in the working fluid cavity. It may also have the same fluid present as in the working fluid cavity, but may have a different pressure.

The upper separation plate may be free to travel vertically, which may allow pressures to equalize across the upper separation plate 60 through the movement of the upper separation plate 60. Accordingly, by increasing the pressure in the upper pressurized cavity 65 the upper separation plate 60 may be moved downward and by decreasing the pressure in the upper pressurized cavity 65, the upper separation plate 60 may be moved up. (It should be understood that either of the pressurized cavities should be understood to have the potential to be pressurized or to have a vacuum drawn).

A potential benefit of the ability to move the upper separation plate up and down is that the large majority of the volume of the fluid in the working fluid cavity 64 may be expelled by moving the upper separation plate 60 downward toward the lower separation plate 56, with an off-take port 4 opened. An additional benefit is that fluids may be drawn into the assembly by raising the upper separation plate 60 while an intake port 4 is open to set an initial environment for processing. Finally, the pressure of the working fluid during processing may be controlled by controlling the pressure in the upper pressurized cavity 65 via a separate pressurization port 67.

As the mixer blade rotates, materials that have accumulated at the bottom of the working fluid cavity 64 may be agitated and mixed. The agitation of the materials by the mixer blade 52 may break the materials into finer particle sizes, enhancing the desired chemical reactions. The rotation of the mixer blade 52 may also help to mix and circulate the working fluid in the working fluid cavity 64, providing additional temperature uniformity and homogenization of the mixture.

The motion of the upper separation plate 60 may be controlled by fluid flow into and out of the pressurized cavity above it, but it could also be controlled by a motor or other actuation mechanism. In one embodiment, the upper separation plate 60 may be designed with internal recesses to match the shape of the mixer blade, so that the upper separation plate 60 may be brought down very close to the lower separation plate, with the mixer blade nesting into a mating cavity in the upper separation plate 60. In the absence of a lower stop ring 63, this would permit the upper separation plate 60 to move down very close to the lower separation plate 56, which may allow the apparatus to nearly fully exhaust the working fluid.

While an upper separation plate is shown in this figure, it should be understood that any number of configurations may be utilized within the cartridge to displace the working fluid with a secondary fluid, so that the working fluid may be expelled when a valve is open, or to use a secondary fluid to control pressure. For example, a balloon or bellows inside a working fluid cavity could also be inflated via a secondary port to displace the working fluid, and a variety of other configurations may be practicable, which may employ the use of a second fluid and a moveable barrier that seals or at least partially seals in place some sort of movable barrier between the two fluids.

As with the drum cartridge 1, the mixing cartridge 68 or other cartridges may be indexed between processing stations, with a common interface of ports to facilitate the automation of indexing. Several of the other features of the drum cartridge including the action of the various ports may also be applicable in the case of a mixing cartridge or other cartridge configurations, including the potential use of an independently driven or blower to circulate the working fluid, the use of common port interfaces, etc.

As with the drum cartridge 1, the mixing cartridge 68 may employ heating elements to maintain a desired internal working temperature. Additionally, as with the drum cartridge, flow mechanisms may be established within the mixing cartridge 68 to agitate or circulate the working fluid. In particular, in the embodiment of a mixing cartridge 68, lower or upper mixer blades on the rotating shaft may be of utility in circulating and mixing the fluidic components of the working fluid cavity with the solid components.

State-of-the-art methods of producing volatile compounds from thin compressed layers of biomass do allow for somewhat uniform heating of biomass and permits some volatile materials to escape from the biomass. However, the top surface of such thin layers continues to have a different thermal profile from the bottom surface, and the materials on the bottom surface must diffuse volatile compounds through the packed material, as opposed to the surface materials, which may evolve volatile materials directly into the surrounding working fluid environment. To enhance thermal conductivity and gain even moderate thermal uniformity, this thin layer is often compressed, but such compression works against the desired diffusion effects. Thus compressing the biomass into a thin layer increases particle size, reduces surface area, and reduces diffusion while failing to achieve ideal temperature uniformity.

According to the present invention, solid materials such as biomass may be processed in an uncompressed state with smaller effective particle size and improved temperature uniformity. Because the solid feedstock is processed as finer particles, in an uncompressed state, there is more surface area available to the fluid reactants, and the lack of compaction improves diffusion rates.

The agitation and mixing of the biomass according to the present invention has several additional benefits. The mixing of the biomass itself ensures greater uniformity of temperature across the biomass materials, which in turn, allows a greater volume of biomass to be processed at a given time, increasing production rates and decreasing capital costs per unit of renewable fuels output. The mixing may also act to disperse the biomass into smaller particles, increasing the surface area of biomass in contact with the working fluid. Finally, through the cascading effects of the repeated collisions in mixing, some of the larger particles may tend to break down into smaller particles, further increasing surface area and production rates.

The enhanced mixing of the biomass with the working fluid may accelerate the evolution of volatile compounds. Additionally, the flow of the fluid relative to the biomass accelerates volatilization of the compounds. This may be particularly true if there is the addition of an internal fan to circulate the working fluid, as shown in FIG. 2. In addition to the mixing of the biomass providing more consistent composition and temperature uniformity of the solid feedstock, such as biomass, the mixing of the fluid provides more consistent fluid composition and temperature as well. Of particular note is the minimization of boundary layer effects at the fluid interface to the solid material, which may form in a stable layer over a flat plate of biomass in a tray, but would be of much less significant of an effect in an agitated cartridge apparatus, as is described by this invention, particularly with agitated solid particles and/or additional forced working fluid circulation.

The motion of any agitation mechanism may heat the mixture to some extent through frictional effects. If this is desirable and sufficient, it may be the only form of heating used in the process, with temperatures controlled by the mechanical energy imparted via measured rotational motion. If the heat provided is excessive, a slower or pulsing motion of the agitation mechanism may be appropriate to provide mixing, with less of a heating effect.

The duration of the mixing process may be controlled via any one of a number of parameters. At the simplest level, it may be controlled via a pre-established count of rotations, or by mixing for a fixed period of time. It may also be controlled by monitoring the working fluid trapped in the drum cartridge, measuring temperatures, pressure changes or even changes in the chemistry of the working fluid that may indicate that it is time to progress to the next working station.

The processing of specific biomass mixtures may also benefit from dwell periods for reactions to progress or for volatile compounds to evolve from a solid substrate, such as volatile compounds being produced by biomass during heating. During these dwell periods, temperature, pressure and temperature may be stabilized, or may follow a prescribed protocol. In the case of agitation, agitation may be halted or continued during these dwell periods, as may be the circulation of working fluid, if controlled independently.

The cartridges described herein are example systems that may be used to achieve the benefit of providing a sealed cartridge containing both a solid material being processed and a local working fluid environment. As will be apparent in light of this disclosure, any sealed vessel or cartridge capable of containing both a solid material and a working fluid is suitable for use with an embodiment of the present invention and could be operated utilizing similar principles. In particular, a sealed cartridge could also be provided where there is no internal mixing device, but nonetheless permits a working fluid to be passed station to station in conjunction with a solid reactant such as biomass.

Another benefit of the present invention is to provide for agitation of the solid feedstock or reactant. The solid feedstock or reactant, such as biomass, may be agitated by a variety of means. FIG. 1 shows a rotary drum apparatus suitable for agitation, and FIG. 4 shows a mixer blade apparatus. However, as will be apparent in light of this disclosure, agitation could also be performed by any other means. For example, agitation could be performed inside the cartridge using an internal motor driven by electrical signals from the outside, by a motor with a stator and rotor pair spanning a sealed gap, or an external motor attached to a rotary shaft which penetrates the cartridge. Further examples of agitation include agitating the cartridge itself externally, via rotary motion, oscillatory motion, vibratory motion, or some combination of these effects, potentially also including an internal mixing device such as internal ribs or ball bearings for driving internal movements and mixing of the internal working fluid and/or solid contents as the cartridge may be moved from the outside. Any other suitable agitation means are also acceptable.

In addition to agitating the biomass, it may be advantageous to concurrently agitate or circulate the working fluid included in the cartridge. The present invention allows for agitation and/or circulation of the working fluid. The fan shown in FIG. 2 is one example method of doing so, and many others will be apparent in light of this disclosure. Specifically, for example, flow may also be established by circulating flow through the intake and off-take valves. In alternative examples, flow or agitation of the working fluid could be a result of the agitation and circulation of the solid feedstock itself, as may occur naturally in a mixing cartridge as shown in FIG. 4 or in other embodiments where the biomass is agitated, or as a function of a heating process.

Another aim of the invention is to provide controlled heat to the mixture being processed. Heat may be provided by conduction from resistive heating elements in the base plate (as shown in FIGS. 1 and 2), or by various other means. For example, heat may be provided by microwave or infrared energy, by the addition of heated working fluids, through the use of a plasma, by introduction of heat with the working fluid via the intake port, by warming the exterior of the cartridge, or by various other methods.

Yet another goal of the present invention is to provide controlled pressure to the biomass and working fluid. The pressure on the working fluid may be controlled by flowing fluid into or out of the intake or off-take ports respectively, as may be appropriate, or by controlling temperatures and fluid compositions, which may also have an impact on working pressure. Additionally, the control of pressure may be accomplished by having a movable element which separates the working fluid in the container from a second fluid, which may be utilized to control the pressure on the opposite side of the movable member.

Further, the invention provides ports for the intake and/or off-take of working fluid. The intake and off-take and ports may be attached to a base plate or to a cover, and may be actuated by electrical or mechanical means from outside of the cylinder. There may be one port that is used both for intake and off-take, or there may be multiple ports used for different purposes.

Another aim of the invention is to provide ports for the measurement of process parameters. Process parameters such as temperature, pressure and fluid composition may be measured by various means. Internal sensors may be mounted within the cartridge, with electrical signals being passed outside of the cartridge via electrical connections. Alternatively, fluid temperatures, pressures and compositions may be obtained by flowing fluid into our out of the cartridge, or by inserting probes into the cartridge to measure those parameters. Finally, optical sensing through a lens in the cartridge may be a practicable way to determine certain parameters.

A goal of the present invention is to allow solid feedstock or reactants to be added to the cartridge and/or to clean the cartridge. FIG. 1 shows a separable cover and base plate, which thereby permit removing the cover to enable the addition of biomass and the cleaning of the cartridge. There may be a number of ways to accomplish this function, which include having a separable assembly with integral seals that permit the entire cartridge to be resealed once reassembled. But the geometry of the cartridge could be cylindrical, spherical, a rectangular prism or other geometries. In some configurations it may even be possible to allow for a fill and/or cleaning port which does not require full disassembly of the cartridge.

Yet another goal of the present invention is to advance the cartridge through successive processing stations. Advancement of the cartridge may be achieved via a number of means. Most simply, mechanical advancement of the cartridge to the next station using a conveyor or rotary platform that indexes in fixed increments may allow the trays to progress through a number of stations. The use of cartridges according to the present invention can, in some example embodiments, maintain the fluidic environment during the transition from one station to the next while processing one batch of solid materials. Among the many advantages of this cartridge-type station design, each station may process biomaterials at different temperatures, pressures and/or mixing speeds. Such processing can be performed independently using equipment with a common set of interfaces between each cartridges and each station, reducing the costs of construction, operation and maintenance.

The present invention also aims to allow working fluid in the cartridge to be changed at specific points during processing. The working fluid inside the cartridge may be changed over by purging the cartridge. Alternatively, turnover of the working fluid may be enhanced by forcing the working fluid out of the cartridge through the use of a movable or expandable member, such as a separation plate, which may separate the working fluid from a second fluid inside the cartridge which may be used to displace the working fluid, or to draw in a new mixture of working fluids.

Stationary Pressure Chamber Embodiments

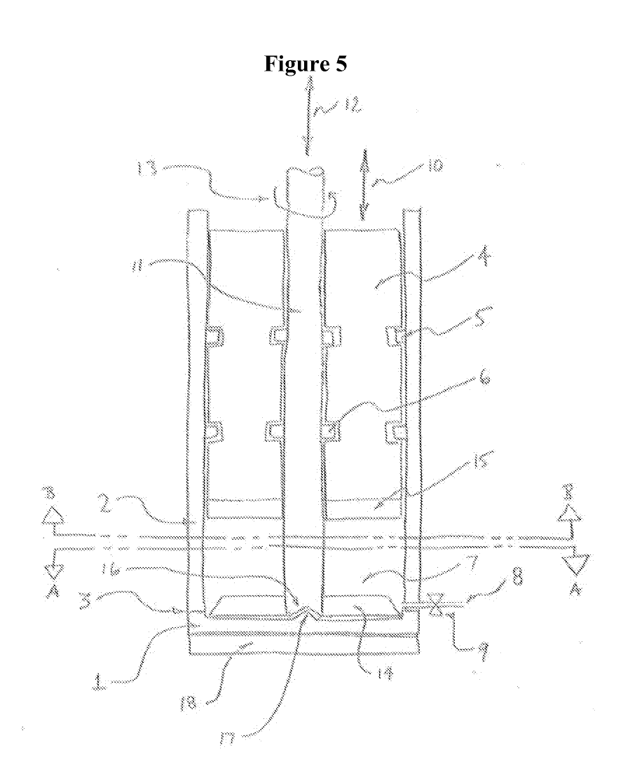

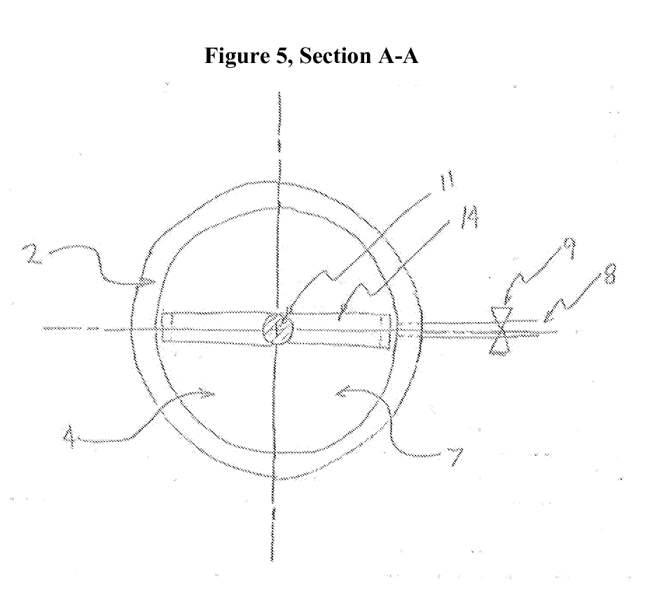

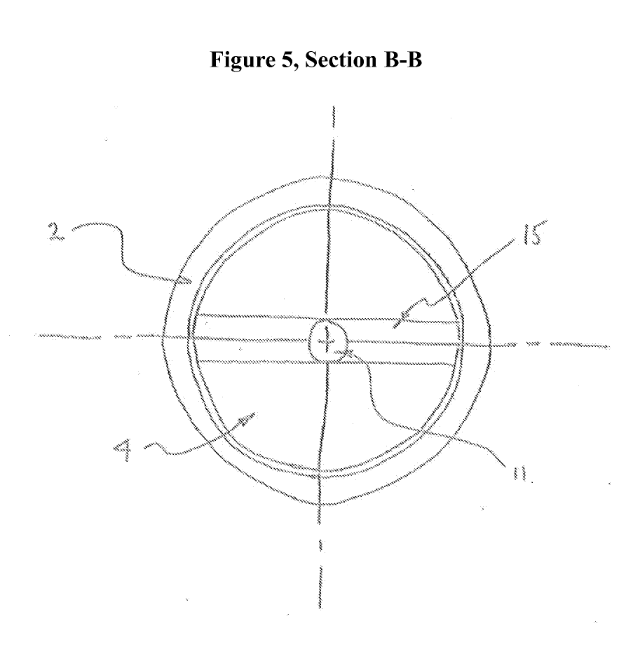

FIG. 5 shows a piston-cylinder-agitator assembly for the purpose of fractionating biomass fuels. A disc tray 101 may be used to hold a thin layer of biomass such as, for example, celluloses, hemicelluloses, lignin, starches, and/or lipids on its top surface, containing the biomass inside a raised perimeter rim. When processing the biomass, the disc tray 101 may be brought into contact with a cylinder 102 with a seal 103 at the junction of the cylinder and disk. This may be accomplished by raising the disc tray 101 into contact with the cylinder 102, or lowering the cylinder 102 into contact with the disk tray 101, thereby compressing the seal 103. A piston 104 may be used with outer seals 105 to the cylinder and inner seals 106 to the agitation element 111 to contain the working fluid in the working fluid cavity 107 created between the piston 104, cylinder 102 and disk tray 101. The seals may be of a compressed, deformable nature (such as an O-ring) or of a rigid sliding nature (such as composite polymer engine rings), depending on the speed of actuation of the piston, the operating temperatures and pressures and the level of sealing required, and where one seal is shown in several interfaces, multiple seals may be employed.

The working fluid may be injected or extracted via ports 108 (only one shown) that may be opened or closed by associated valves 109. In some example embodiments the composition of the working fluid(s) can be, for example, supercritical carbon dioxide, water, methane, methanol, other small hydrocarbons, their oxygenates, and any mixture thereof (e.g. 60% CO₂, 30% Water, and 10% Methane and other organics), although any suitable gaseous, liquid, supercritical, or multi-phase fluid may be used. As the piston may be actuated to move up or down, the working pressure in the working fluid cavity 107 may be increased or decreased in a controlled manner with the valves 109 closed. In some example cases the pressure can be, for example, in the range of 0-220 atmospheres (e.g. 45-80 atmospheres), but various embodiments may use any pressure suitable for processing. For instance, the piston may decrease the volume of the cylinder by greater than or equal to 50%, 75%, 90%, 95%, 98%, 99%, or 99.5%. When an intake valve may be opened, retraction of the piston 104 may be utilized to draw a prescribed working fluid into the working fluid cavity 107. Similarly, when an outlet valve may be opened and an inlet valve closed, the downward movement of the piston 104 into the working fluid cavity 107 may be used to expel the fluid contents of the working fluid cavity. While only one port and one valve is shown, it will be apparent in light of this disclosure that multiple ports or multiple valves on a single port may allow for the effective channel of inlet and outlet fluid flows, or that the port may be positioned at different locations in the cylinder, or even in the disc tray or piston. With all ports closed, and during a heating process in which volatiles are extracted, the cylinder may be retracted in a controlled manner to maintain pressures or to follow a prescribed pressure profile optimized for that processing step (e.g. pressure variations within the range of 0-220 atmospheres).

The agitator drive shaft 111 may be actuated in two directions by actuators (not shown). The agitator may be moved up and down as shown by the arrows 112 and also may be rotated about its axis as shown by the arrow 113. To the bottom of the agitator drive shaft 111 are attached one or more mixer blades 114, with two shown at 180 degrees in this embodiment, though it will be apparent that any number of mixer blades may be appropriate.

In the illustrated embodiment, the agitator shaft has an alignment conical chamfer 116, which allows the agitator drive shaft to ride in a raised cone or boss 117 in the disc tray 101. This has the advantage of stabilizing the agitator drive shaft as the mixer blades come into contact with biomass as the agitator drive shaft 111 may be rotating, causing the mixer blades 114 to mix the biomass with the working fluid in the working fluid cavity 107. It has the secondary advantage of wiping biomass particles off of the central axis of the disk tray, where they may experience less homogeneous mixing than in the area where the mixer blades are rotating. It should also be understood that the raised cone or boss on the disc tray 117 may also be allowed to rotate with the agitator shaft 111 through the use of a bearing allowing it to rotate relative to the disk tray 101 or a rotary element sealed to and penetrating the disk tray.

If a mixing process is utilized, when the mixing process is complete, it may be advantageous to raise the agitator shaft 111 above the disk but below the piston, to allow it to rotate freely in the working fluid cavity 107, which allows for any biomass remaining on the mixer blade to be cleaned off of the mixer blade and to drop back down into the disk tray 101. It may be helpful to spin the mixer blade at high speeds, to reverse the motion of the mixer blade rapidly, or even to tap the mixer blade against the piston to facilitate shaking loose biomass which may have adhered.

It may also be the case that biomass materials adhere to the walls of the cylinder during processing. In this case, the mixer blades 114 may be designed with a close tolerance to the cylinder 102, so that the rotary action of the mixer blades acts to clean the sidewall of the cylinder. It may also be helpful if the piston 104 has a tight clearance to the cylinder 102, with an angled approach of the piston rim to the cylinder wall such that the outermost diametrical points of the piston come into contact with biomass adhering to the wall and act as a knife scraper on the sidewall of the cylinder, scraping materials back into the interior of the cylinder.

At certain times during the processing of a biomass sample, and in particular after mixing or prior to heating the biomass, it may be advantageous to level the biomass in the disk tray. In other words, at the end of the mixing process, the biomass may be distributed unevenly, or toward the outer edge of the disk tray. For uniform heating or subsequent processing, it may be helpful to reestablish a thin level layer of biomass on the disk tray. This may be achieved by lifting the mixer blades 114 so that the bottom of the mixer blades are above the expected level of the flattened biomass, and utilizing a rotary or oscillatory mixer blade to level the biomass. It may also be helpful to withdraw the mixer blade to nest up into the piston, so that the piston may be brought down to press down the biomass, further leveling it. It should be readily understood by one skilled in the art that any number of leveling iterations of using the agitator to level the biomass and pressing down with the piston may have utility in leveling the biomass. It should also be understood that the application of pressure by the piston during heating may facilitate the heating process by enhancing conduction.

When mixing of the biomass may not be required for a specific processing step, it may be advantageous in some embodiments of this invention to withdraw the mixer blade upward into a mating groove 115 in the piston 104 as shown in FIG. 5 Section B-B. The presence of this mating groove 115 in the piston 104 also allows the piston bottom surface to come down very nearly to the top of the disk tray 101. This may allow the working fluid cavity 107 to be driven to a de minimis volume, which in turn may allow for the expulsion the substantial majority of the working fluid if the exhaust valve were opened. It may also allow for the effective intake of a new working fluid by raising the piston with an intake valve opened. Alternatively, the piston may be utilized for the generation of higher pressures by moving the piston downward while the valves are closed. To accomplish the nesting of the mixer blade, the mixer blade may be timed to the piston in terms of its angular position via rotation of the mixer blade and/or rotation of the piston itself.

Underneath the disk tray 103, a heating element may be embedded in the base plate 118, allowing that heat may be produced and transmitted through the disk tray 103 to the biomass and working fluid enclosed in the working fluid cavity 107. Processing temperatures often vary and may be, for example, in the range of 190-850° K. (e.g. 304-798° K, 512-748° K., or 598-698° K.), but may, in various embodiments, be any temperature suitable for processing. The disk tray may then be indexed to move through successive processing stations (not shown), where the heat and pressure at each station may be carefully controlled in processing. In some embodiments the temperature may be increased at each new station by increments such as, for example, in the range of 0-200° K. (e.g. 25-50 K), although it will be apparent in view of this disclosure that any station-to-station temperature increment suitable for processing may be used. In addition, through the systems and methods described herein, the intake of working fluid, the agitation of materials during processing and the exhaustion of working fluid at each station may be carefully controlled.

FIG. 5, Section A-A shows a downward oriented view of the mixer blades 114 being driven by the agitator drive shaft 111. The mixer blades are resting on or near the base of the disc tray 101, above which the working fluid may be contained in the working fluid cavity 107. By rotating the mixer blade 114 using the agitator drive shaft 111, the biomass in the base of the disk tray 103 may be agitated. The biomass and working fluid are contained by the cylinder 102 and above by the piston seals (not shown in this section). Working fluid may be allowed to enter or leave the working fluid cavity 107 by means of one or more valves 109 controlling flow through one or more ports 108. As is shown in the section view of the mixer blade in FIG. 1, the mixer blades may be chamfered to contact the base of the disk tray around the perimeter of the disk, while being tapered back to prevent the mixer blades from blocking flow into the intake or exhaust ports. Because it might be natural for the biomass to be thrown into intake or exhaust ports by the mixer, geometric traps and or screen filters may be included in the ports' design, and it may be advantageous to reverse flow at times in the ports to ensure that ports do not become clogged by biomass.

FIG. 5, Section B-B shows a section view looking upward at the piston 104 from the working fluid cavity 107. In some embodiments, as illustrated, the bottom of the piston 104 may contain a groove 115 (which could also be a series of grooves, depending on the nature and orientation of the mixer blades 114) which may allow the mixer blade to slip up into the piston when it is not in use. In order to assure that a maximum quantity of biomass may be returned to the transfer disk after processing for a stated period in this station, the mixer blades 114 may be elevated above the disk tray 101 but below the piston 104 so that any biomass on the mixer blades 114 may be dispelled and drops to the transfer disk. Then the mixer blades 114 may be refracted using the agitator shaft 111 and aligned with the groove 115. Subsequently, the piston may be moved downward with an exhaust valve open, in order to exhaust the volatile compounds produced during the heating and mixing process.

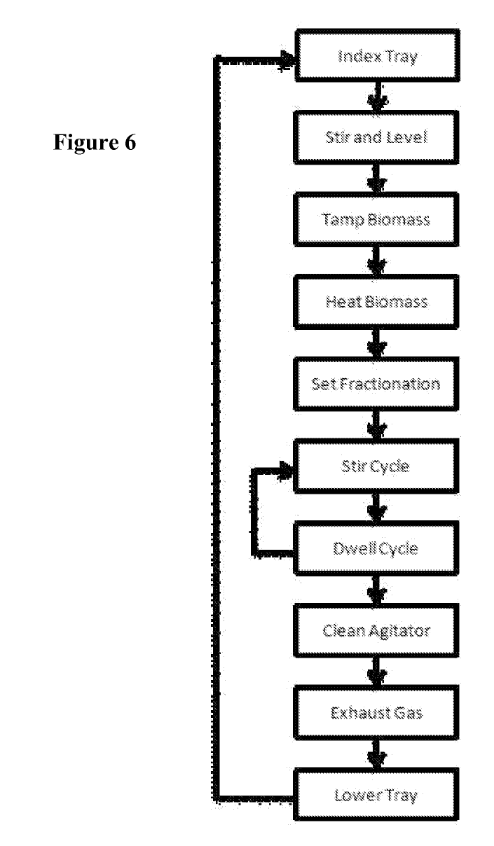

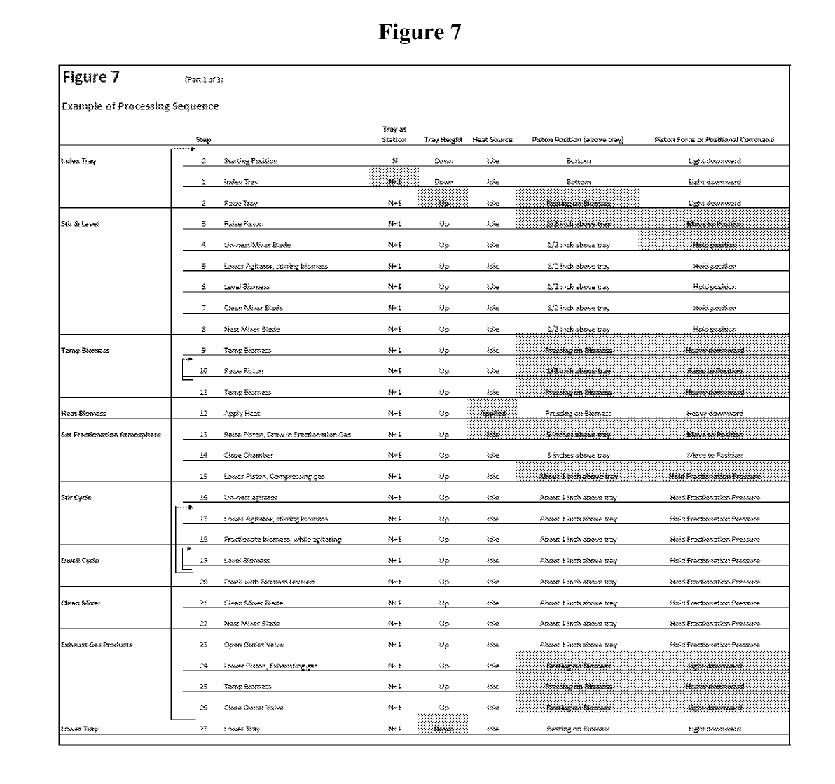

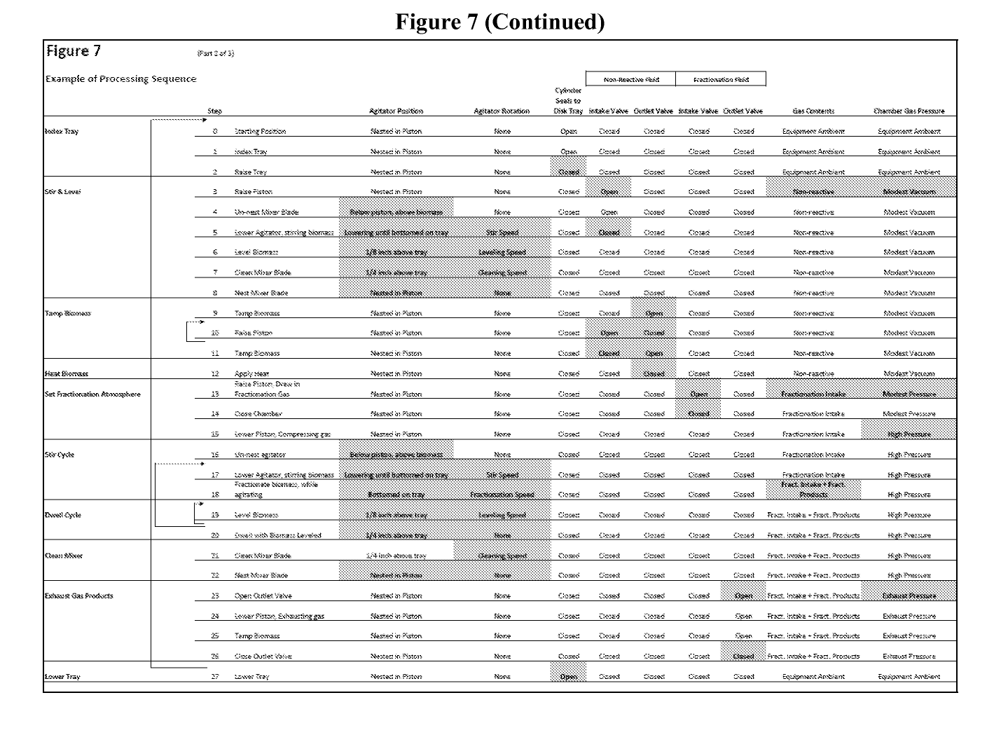

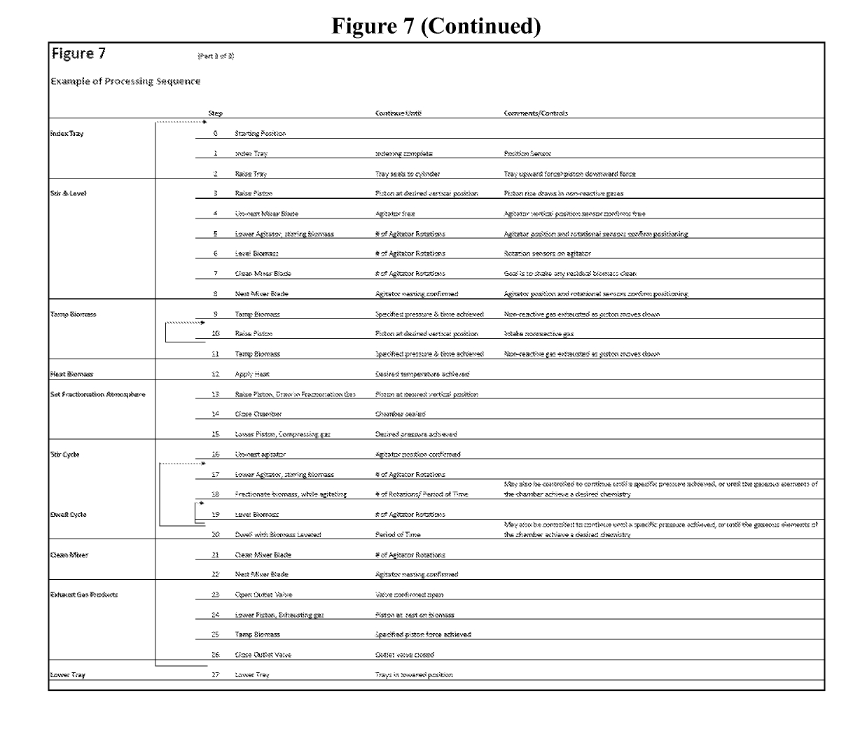

FIG. 6 shows an overview of processing steps at a particular work station, and FIG. 7 shows the detailed process steps in one exemplary implementation. In particular, FIG. 7 shows one potential sequence for the movements of the piston and agitator, the action of seals and valves, the application of heat, the progression of the fluid contents of the cylinder and several control considerations during processing.

The sequence shown is but one example, and it will be apparent in light of this disclosure that not all steps are included in all embodiments. It will be further apparent that any number of variations may be preferred to optimize a particular processing step. As an example, the application of heat could be provided via the disk plate prior to stirring, as is described here, or it could be provided in the cylinder itself during mixing by a variety of means, including the introduction of hot working fluids, plasma energy, microwave energy, or even to some extent by the action of the agitator itself. Multiple heating, stirring and dwelling sequences could occur in a single processing chamber, in coordination with the application of planned temperature and pressure profiles.

The disk tray may be first indexed to a workstation, where it may be coupled to a cylinder and sealed against that cylinder. Indexing between stations can be accomplished along a circular or elliptical racetrack or other suitable design. Prior to sealing against the cylinder, the disk tray may be exposed to the ambient environment or a specified environment may be maintained over the disk tray through the use of sliding seals and airlocks. If it is exposed to an ambient equipment environment, that environment may be maintained by external seals around the entire operating mechanism of multiple cylinders and processing stations, to prevent volatiles from reaching the exterior atmosphere, and also to provide a controlled working fluid for production.

In this example, the disk tray may then be lifted up against a seal on the bottom of the cylinder, to create a sealed volume between the disk tray, the cylinder and the piston. It will be apparent in view of this disclosure that sealing could be accomplished by several methods, including, for example, circumferential seals, face seals, or some combination thereof, and that the orientation of disk tray and cylinder are somewhat arbitrary in that the tray could be lifted up to the cylinder, the cylinder could be lowered, or the disk and cylinder could be oriented other than vertically and simply brought together to form a seal.

As the tray may be lifted into place and a seal may be formed with the cylinder, the biomass in the tray may come into contact with the piston, which was resting near the bottom of its travel, but which may be permitted to move up freely as the rising tray lifts the biomass to contact the piston. This may ensure that there is a minimum volume of equipment ambient fluid trapped above the biomass as the cylinder seal may be formed.

Next a valve may be opened allowing a controlled working fluid mixture to enter the chamber while the piston rises. It should be understood that differing working fluids may be employed at different processing stations, and at different stages of processing within a given station, and that the operating temperatures and pressures of the working fluids may be varied as well. For example, if it is desired to drive the volatilization of specific compounds from a mixture in a narrow band of temperature, it may be helpful to utilize a working fluid mixture that retards the evolution of those compounds until the biomass is thoroughly mixed and the desired temperature has been reached. Then it may be advantageous to change over the working fluid composition to a working fluid composition designed to effectively draw off those volatile compounds, or to speed the biomass decomposition that gives rise to them.

For the purpose of clarity, in this example, the working fluids, some examples of which are described herein, which are intended to discourage the evolution of volatiles are referred to as “non-reactive” in FIG. 7, while the fluids intended to promote the evolution of volatile compounds are referred to as Fractionation Intake Fluids (or after volatile organic products have been produced, are referred to as Fract. Intake+Fract. Products) in FIG. 7. It should be understood that there may be some reactions that occur when “non-reactive” fluids are utilized, but the distinction is between fluids designed to accelerate or retard reactions or diffusion during processing.

In some example embodiments the composition of the fluid mixture can be, for example, supercritical carbon dioxide, water, methane, methanol, other small hydrocarbons, their oxygenates, and any mixture thereof (e.g. 60% CO₂, 30% Water, and 10% Methane and other organics), although any suitable gaseous, liquid, supercritical, or multi-phase fluid may be used. The next processing step may involve stirring and leveling the biomass, prior to further heating of the biomass, and it may not be desirable to drive volatilize compounds until that process is completed and the biomass is uniformly mixed and warmed. So the working fluid environment for mixing and stirring may be different in fluid composition and may differ in pressure and temperature from the working fluid subsequently used to fractionate the biomass and create the volatile products of the fractionation process.

After raising the piston above the biomass, the mixer blade, which had previously been nested in the piston, may be lowered so that it may freely rotate in the gap between the piston and biomass. For example, if there is ⅛ inch of biomass on the tray, the piston is raised 1 inch above the tray and there is a ⅞ inch gap, a mixer blade of ⅜ inch thickness could freely rotate unobstructed in the gap between the biomass and the piston with ¼ inch of clearance above and below.

The mixer blade may then be lowered into the biomass to stir the biomass, and it may be advantageous to lower the blade while it also may be rotating. The blade may be lowered so that it touches the bottom of the tray, and a scraping blade may be present on the bottom of the mixer blade to help remove biomass that may be adhering to the disk tray.

After a specified period of mixing, the mixer blade may be raised to approximately ⅛ of an inch above the tray, so that the stirring motion acts to level the biomass into a flat plane below the mixer blade. During this time, it may be advantageous to reverse the direction of the mixer blade, so that, instead of a scraping action, angled blades may have a smoothing action.

Subsequently, the mixer blade may be raised to clean the mixer blade. Cleaning of the blade may be accomplished by high velocity rotation, by sharp reversals in direction, and even by raising to contact and impact against the piston while in motion, shaking loose residual materials.

In addition, during this processing step, it may be advantageous to utilize the mixer blade to clean the piston walls. If the clearance between the mixer blade and cylinder walls is small, the walls may be cleaned by rotating the mixer blade near the wall, and slowly raising or lowering the mixer blade to clean the wall. Once the substantial majority of material has been cleaned from the mixer blade, it may return for one more leveling pass and one more cleaning cycle, or it may return to its nested position in the piston.

Now that the biomass material may be thoroughly mixed, the next step in this illustrative example might be to compact the biomass by tamping down on it with the piston. This may be an iterative process, where the piston pushes down on the biomass, raises up, and then pushes down again. As the piston may be moving up and down, it may be advantageous that valves controlling the flow of the non-reactive working fluid are timed to open and close so that appropriately non-reactive mixtures at the appropriate pressure and temperature are drawn in on the up-stroke, and any volatiles produced are exhausted to an appropriate downstream process on each down-stroke. Alternatively, the fluidic contents of the piston may simply be compressed during this phase of processing, along with the biomass itself.

In one example embodiment, a homogenous and compacted layer of biomass on the disk tray may subsequently be heated, for example, by conduction through heating the tray. This is only one example method for heating the biomass, and many other heating methods will be apparent in view of this disclosure. The timing of the heating of the biomass can be varied as part of the cycle as well. For example the biomass may be heated within the cylinder by the introduction of a pre-heated fractionation working fluid during a subsequent processing step, or may be heated by a plasma, by microwave energy or by various other means that will be apparent in view of this disclosure. Processing temperatures often vary and may be, for example, in the range of 190-850° K. (e.g. 304-798° K., 512-748° K., or 598-698° K.), but may, in various embodiments, be any temperature suitable for processing. Though it is not prescribed in this illustrative example, additional iterations of stirring, leveling and tamping may be performed following heating, in combination with additional iterations of heating, as may be appropriate to generate a homogenous mixture at the desired temperature or temperatures. During these various pressurizing and heating processes, the biomass may go through multiple steps of decomposition and progress, for example, from an initial state which may be of a lipid rich biomass to an intermediate state of hemicellulose rich biomass to a final state of lignin rich biomass. In one example, a hemicellulose type of biomass may comprise C5 sugars such as fructose and xylose, which then further decompose to yield compounds such as furfurals and hydroxymethylfurfurals.

During the decomposition of the biomass in tightly controlled windows of temperature, pressure and working gas composition, specific targeted volatile compounds may be produced, which then may be subsequently reacted in a catalyst chain to produce renewable fuels, such as gasoline.

Following heating, a valve may be opened permitting the entry of the desired starting working fluid for the evolution of volatile compounds. This working fluid may be drawn into the chamber by the upward motion of the piston with the intake valve opened. In this example, the piston may be brought back, for example, approximately 5 inches with the valve opened and a working fluid can be thereby drawn into the piston. The working fluid may be, for example, a high pressure supercritical fluid to provide a reduced oxygen environment but working fluids will vary and most typically will be determined by the reactants being used and the desired volatile reaction products. Then, by lowering the piston back down toward the disk plate with the intake and exhaust valves closed, the pressure in the chamber may be further increased.

Through this mechanism, the movement of the piston may be used to control the pressure which, in some example cases can be, for example, in the range of 0-220 atmospheres (e.g. 45-80 atmospheres) or any other pressure suitable for processing, of the working fluid mixture during this and subsequent steps. As the biomass produces volatile compounds that would otherwise increase the pressure in the chamber, the piston may be refracted to hold pressure, or the piston's motion may be controlled to increase or decrease pressure during subsequent processing steps as may be optimal for the extraction of these volatile compounds.

With a homogenous, heated biomass mixture resting on the baseplate and the desired working fluid above, the biomass may now be agitated to maximize the production of volatile compounds. Specifically, the mixer blades may be lowered from their nested position in the piston, and the mixer blades rotated and lowered to stir the biomass.

The mixing of the biomass with the working fluid may accelerate the evolution of volatile compounds. This occurs because the action of the mixer at the base of the cylinder acts to throw biomass up above it into the working fluid cavity, dispersing the biomass into smaller particles, and breaking the flat disk of biomass into smaller fragments and particles. Additionally, the rapid flow and mixing of the working fluid with the biomass accelerates volatilization of the compounds. Because the larger fragments of biomass may tend to stay preferentially toward the bottom of the chamber, they are more often reduced in size, leading to a more homogenous particle size.

The motion of the mixer may heat the biomass through frictional effects. If this is desirable and sufficient, it may be the only form of heating used in the process, with temperatures controlled by the mechanical energy imparted via measured rotational motion. If the heat provided by mixing is excessive, a slower or pulsing motion of the agitator may be appropriate to provide mixing, with less of a heating effect.

The duration of the mixing process may be controlled to any one of a number of parameters. At the simplest level, it may be controlled via a pre-established count of rotations, or by mixing for a fixed period of time. It may also be controlled by monitoring the working fluid trapped in the piston, measuring temperatures, pressure changes or even changes in the chemistry of the working fluid that may indicate that it may be time to progress to the next working station. Finally, if pressure is being held constant by a piston's movement, the motion of the piston to a particular point may indicate that a certain volume of volatile compounds has been produced, and it may be the optimal time to progress to the next step in the process.

The processing of specific biomass mixtures may also benefit from dwell periods for reaction and for the production and diffusion of volatile compounds. During these dwell periods, the agitation may be halted, and the mixer may first level the biomass on the heating plate, and then may allow the biomass to sit as volatile compounds are released. If additional heat input may be desired, further compaction of the biomass may be accomplished by pressing down the piston on the biomass, but if heating is sufficient, it may be more efficacious to allow the volatile compounds to be drawn off of the biomass in an uncompressed state with improved fluid flow to the individual particles.

This next dwell step of the process may involve the production of volatile compounds from a thin layer of compressed biomass, during which the biomass may be subjected to a prescribed temperature and pressure profile. However, there are advantages possible from the availability of an agitator mechanism. The materials may be cycled through multiple iterations of volatile compound evolution when mixing and when in a leveled material dwell. In addition, instead of the material in the top layer of the disk tray remaining on the top layer for the duration of a processing step, and across multiple processing steps, the agitation mechanism allows for mixing of materials for more homogenous volatilization of the organic compounds in the biomass within each station, and then again at each subsequent station.

Following multiple potential iterations of agitation and dwell periods (and with the understanding that cases of no agitation or no dwell periods may be advantageous for processing in certain conditions), during which the desired quantity of volatile compounds may have been extracted from the biomass, the mixer blade may be withdrawn to the working fluid cavity above the biomass and cleaned as has been described above. Following cleaning of the mixer blade, the biomass may be leveled, and the sequence of cleaning and leveling may be iterated multiple times to achieve both a level tray of biomass and a clean mixer blade, which may then be nested back into the piston.

With the mixer blade nested in the piston, the outlet valve for the working fluid may be opened as the piston may be moved down, nearly completely exhausting the working fluid from the piston-cylinder assembly. At this point, the biomass may also be tamped down, to push out remaining fluid that may be trapped in the biomass pile, and also to slow further reaction during passing the tray to the subsequent processing step. The outlet valve for the working fluid containing the volatilized compounds may then be closed, sealing off the chamber, and finally the tray may be dropped, allowing the disk tray to increment to the next station.

The various elements described in the above embodiment perform certain functions, but those functions may be achieved through alternative means. Several beneficial functions and alternative means of achieving them are described below.

The invention aims to provide a seal between the disc tray and the cylinder. Such seals between the cylinder and the disk tray may be a face seal (as shown in FIG. 5), a radial seal or some combination of multiple seals.

Another aim of the present invention is to provide ports for the intake or exhaustion of working fluid. The intake, exhaust and measurement ports may be included in the side of the cylinder (as shown) or by using ports penetrating the cylinder, disk tray or even the piston.

Further, the invention aims to provide controlled heat to the biomass and working fluid. Heat may be provided by conduction up through the disk tray (as shown), by heating elements in the cylinder, by microwave or infrared energy, by the addition of heated working fluids, through the use of a plasma, or by various other methods that will be apparent in view of this disclosure.

The present invention also aims to provide controlled pressure to the biomass and working fluid. The pressure on the working fluid may be applied by a piston, or via one of the intake or exhaust ports, as may be appropriate, or may also be used with a movable internal element like a balloon or bladder, which separates a pressurization fluid from a working fluid.

Another goal of the present invention is to measure key parameters of biomass and working fluid. The measurement of heat and temperature of the biomass during processing is not shown, but is readily understood to be practicable by the insertion of a temperature or pressure sensor in a port such as has been shown for the intake and exhaust valves. Measurement of temperature or pressure could also be addressed by measurements on the cylinder wall or through the disk tray. Measurement of the composition of the working fluid's chemistry may also be helpful, particularly in assessing the progress in producing specific products.

Yet another aim of the invention is to provide a controlled method to mix or agitate the biomass during processing. There are a number of ways of accomplishing the mixing function. The mixing function may be accomplished by an agitator driven mechanically from the top by an agitator drive shaft coaxial with the piston. The agitation may be driven from the bottom by a drive shaft protruding through and sealed to the disk tray. The agitation could be driven by a freely rotating element within the piston and cylinder with magnetic properties that allow it to be driven by magnetic fields surrounding the cylinder. Finally, the entire assembly could potentially be shaken or rotated, therefore causing agitation of the materials inside, particularly if there are ribs or movable elements inside the apparatus.

Another aim of the present invention is to allow the chamber and mixer to be cleaned prior to transfer of biomass to the next station. The agitation method described herein may be self-cleaning, to minimize any biomass residuals left in the cylinder above the disk tray at the completion of a cycle, which would otherwise be reintroduced into the next set of biomass introduced at that station. Because presumably that material had already given off a targeted range of volatile chemical compounds, and may now be producing non-targeted compounds, materials that are not fully expelled during a particular cycle have a potential to contaminate the next cycle.

Another aim of the invention is to allow the disk tray to be advanced through successive processing stations. Advancement of the disk tray is not illustrated here, but may be achieved via any suitable means. Most simply, mechanical advancement of the tray to the next station using a conveyor or rotary platform that indexes in fixed increments may allow the trays to progress through a number of stations. One of the advantages of this type of station design may be that each station can independently operate at different operating temperatures, pressures and/or mixing speeds while using a common piston-cylinder architecture, and a set of common interchangeable components, reducing costs of construction, operation and maintenance.

The present invention may also contain some beneficial functions that have not been discussed. For example, actuation of the piston and agitator shaft is not shown, but may be easily accomplished through a variety of means, such as motors, drive screws, cams, levers, crankshafts, linear motors, as may be suitable for any specific embodiment. In one configuration, the top of the piston-cylinder assembly may be fully sealed in order to contain any fluids that may slip through the outer seals 5 or inner seals 6, and the piston and agitator shaft are controlled by motors inside the top of the sealed portion of the assembly that are magnetically coupled to an external set of drive stators located outside the sealed assembly. This has the benefit of providing a full stationary secondary seal containing any volatiles produced.

It should be understood that for certain process steps, agitation of the biomass may not be desirable. Accordingly, the piston-cylinder assembly may also be implemented without mixer blades 114, an agitator shaft 111, or internal seals 106.

It should also be understood that for certain process steps, control of pressure or the intake and exhaust of working fluid with a piston may not be required. Accordingly, a system of agitation may be employed in cases that do not require a piston.

It should be understood that there may be alternative ways to displace the working gas from the working gas cavity than a piston mechanism. An alternative may be a balloon or bellows assembly in the cavity that can be filled from a separate external port with a secondary fluid. This secondary fluid may then be utilized to adjust the volume of the working cavity. Making these adjustments in combination with the action of the intake and exhaust valves, as previously described, may allow the cavity to be substantially purged of its working fluid, to draw in a new batch of working fluid, or to control the pressure on the working fluid, as described previously.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

As used herein, the term ‘biomass’ includes any material derived or readily obtained from plant sources. Such material can include without limitation: (i) plant products such as bark, leaves, tree branches, tree stumps, hardwood chips, softwood chips, grape pumice, sugarcane bagasse, switchgrass; and (ii) pellet material such as grass, wood and hay pellets, crop products such as corn, wheat and kenaf. This term may also include seeds such as vegetable seeds, fruit seeds, and legume seeds.

The term ‘biomass’ can also include: (i) waste products including animal manure such as poultry derived waste; (ii) commercial or recycled material including plastic, paper, paper pulp, cardboard, sawdust, timber residue, wood shavings and cloth; (iii) municipal waste including sewage waste; (iv) agricultural waste such as coconut shells, pecan shells, almond shells, coffee grounds; and (v) agricultural feed products such as rice straw, wheat straw, rice hulls, corn stover, corn straw, and corn cobs.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

1-163. (canceled)

164. A method of fractionating a biomass comprising:
dispensing the biomass into at least one reaction chamber;
injecting a working fluid into the at least one reaction chamber;
subjecting the biomass to at least one specified temperature and pressure profile; and
selectively collecting volatile compounds as they are released.

165. The method of claim 164, further comprising agitating the biomass.

166. The method of claim 164, wherein subjecting includes incrementing at least one of the temperature or pressure based on a measurement of at least one of time, pressure, and working fluid composition.

167. The method of claim 164, wherein the temperature profile is incremented over a range of times, pressures or local working gas compositions.

168. The method of claim 164, further comprising subjecting the volatile compounds collected through a series of catalysts to produce at least one renewable fuel.

169. The method of claim 164, wherein the reaction chamber has a variable volume and the volume can be controlled during fractionating of the biomass to maintain a desired pressure profile.

170. The method of claim 164, wherein the reaction chamber is a sealable cartridge.

171. A processing cartridge apparatus comprising:
a sealable container;
a reaction chamber within the sealable container;
a sealable port for adding feedstock to the reaction chamber; and
at least one sealable fluid port operatively connecting the reaction chamber to the exterior of the sealable container when the fluid port is open.

172. The apparatus of claim 171, further comprising a movable member dividing an interior volume of the sealable container to form a control chamber and a reaction chamber, and a means of moving the movable member so as to change the volume of the reaction chamber.

173. The apparatus of claim 171, further comprising an agitator.

174. The apparatus of claim 171, further comprising a heater to control a temperature of the feedstock

175. The apparatus of claim 171, wherein the reaction chamber is a rotatable drum.

176. The apparatus of claim 171, further comprising an electrical connection positioned on an exterior surface of the sealable container and operatively connected to at least one electrical component.

177. The apparatus of claim 171, further comprising at least one temperature sensor positioned at least partially inside the sealable container.

178. A system of fractionating biomass to extract volatile compounds comprised of:
one or more reaction chambers into which biomass may be injected, the reaction chambers including mechanical means of agitating the biomass, the reaction chambers being capable of subjecting the biomass to a specified temperature and pressure profile, wherein at least one reaction chamber comprising a port; and
a collection device for receiving volatile compounds as they are released via at least one port.

179. The system of claim 178, further comprising a mixing element in a reaction chamber.

180. The system of claim 178, further comprising a heater to control a temperature of the reaction chamber.

181. The system of claim 178, further comprising a piston assembly, wherein the piston assembly controls a volume of the reaction chamber.

182. The system of claim 178, wherein at least one reaction chamber is a piston-cylinder assembly.

183. The system of claim 178, further comprising a filter element operatively connected to the at least one port.
